(19) United States
(12) Patent Application Publication
(10) Pub. No.: US 2017/0000174 A1
(43) Pub. Date: Jan. 5, 2017

(54) PASTY OR LIQUID CULINARY FLAVOR CONCENTRATE

(71) Applicant: Nestec S.A., Vevey (CH)

(72) Inventors: Ramona Jasmin FEZER, Singen (DE); Christoph HANLE, Singen (DE); Martina SCHWAEGERL, Radolfzell (DE)

(21) Appl. No.: 15/106,446

(22) PCT Filed: Dec. 1, 2014
(86) PCT No.: PCT/EP2014/076037

§ 371 Date: Jun. 20, 2016

(30) Foreign Application Priority Data
Dec. 19, 2013 (EP) 13198285.2

(51) Int. Cl. A23L 27/20; A23L 23/10; A23L 29/212

(52) U.S. Cl. CPC A23L 27/20; A23L 29/212; A23L 23/10; A23V 2002/00

(57) ABSTRACT

The present invention relates to a method for making a pasty or liquid culinary flavor concentrate and a culinary flavor concentrate obtainable therefrom. Particularly, the method comprises the step of adding a crystalline salt and/or a crystalline sugar having an average particle size D50 of 150 μm or less to an aqueous composition comprising flavor compounds.

The present invention relates to a method for making a pasty or liquid culinary flavor concentrate and a concentrate obtainable therefrom.

Traditional liquid and/or pasty food concentrates are fat-based and hence have relatively high fat contents. This is not desired anymore by many consumers today, mainly because of nutritional concerns. Furthermore, such concentrates are typically thick and have only a very limited flow-ability and high viscosity. It is difficult for consumers to portion such concentrates directly into a food product from their packaging material without using a spoon, knife or other kitchen utensil.

Where such concentrates are more fluid, i.e. have a lower viscosity, typically more water is contained in those concentrates. This normally results in higher water activity aw values of those concentrates which makes them vulnerable to microbial spoilage. Hence, such products need to be pasteurized after production and remain microbiologically safe as long as they are not opened by a consumer. Alternatively, chemical preservatives can be used, but which is usually not preferred by consumers.

Furthermore, the problem of balancing fluidity versus microbial safety or water activity is usually prominent in flavour concentrate products which comprise starch, and particularly non-gelatinized starch. Such products, depending on the concentration of the present starch, are usually thick with a high viscosity and they are not very flow-able. Such products can usually not be discharged from a container without the use a utensil. Furthermore, such concentrates can also not easily be pasteurized without precautionary measures to not gelatinize the present starch during the pasteurization process. The water activity is thereby a critical parameter.

EP 0 012 465 discloses a pasteurized water-based concentrate in a sealed container. In order to minimise the swelling of starch present in the concentrate during pasteurisation, the osmotic pressure of the composition is increased as to obtain a water activity (aw) of 0.77 to 0.92 using a series of suitable compounds like salts, glycerol, glucose, and protein hydrolysates.

EP 0 970 619 describes ambient stable concentrates which yield, upon dilution with an aqueous liquid, a finished sauce, soup or gravy. The microbial stability is achieved here mainly by a pH of 4 or lower. Since kitchen salt is also added in a proportion of 1% to 8%, the accompanying lowering of the water activity also helps slightly to increase the microbial stability of the concentrate. The water activity of the disclosed examples is between 0.96 and 0.98 at a kitchen salt concentration of 5%.

EP 0 835 614 discloses a semi-fluid, pasty seasoning product that can be used as a sauce aid. The product comprises an oil-in-water emulsion which includes an un-gelatinized starch and a vegetable or fruit powder in a finely divided form containing cell wall and fibre material, which does not completely dissolve in the water phase.

WO 2004/049822 discloses a shelf-stable, fluid and portionable food thickener which contains non-gelatinized starch. The composition is a starch-based fluid concentrate that was obtained by suspending the starch within the aqueous base by the presence of a water activity (aw) depressing agent. This allowed shelf stability without the need of pasteurization. However, this composition presents the disadvantage that a high amount of sorbitol (5 to 50 wt %), a polyol, is used in the composition to get the right texture of the incorporation of the un-gelatinised starch. Sorbitol might not be perceived as very natural and attractive to consumers. Furthermore, certain polyols in too high amounts may have not desired side effects with some consumers, such as e.g. a non-desired laxative effect.

Hence, there is a persisting need in the art and food industry to find better or alternative solutions to the use of e.g. such polyols to make pasty or liquid culinary flavour concentrates, which are on one hand still liquid or pasty enough as that they can be provided in bottles or other containers to consumers for being portioned directly into food products without a use of spoons or other utensils, and on the other hand are shelf-stable and microbiologically safe in that they have a relatively low water activity, despite the fluidity and lower viscosity of those products.

The object of the present invention is to improve the state of the art and to provide a pasty or liquid culinary flavour concentrate that at least goes part way to overcoming one or more of the above mentioned disadvantages of existing pasty or liquid flavour concentrates, or at least provides a useful alternative.

Particularly, the objective is to provide a pasty or liquid culinary flavour concentrate that has a smooth and soft texture and that at the same time maintains a low water activity.

A further objective is to provide a pasty or liquid culinary flavour concentrate that has a low viscosity and that at the same time maintains a low water activity.

A still further objective is to provide a pasty or liquid culinary flavour concentrate that has a low stickiness resulting for example in an improved discharge of the concentrate from a packaging material, and that at the same time maintains a low water activity.

Still further objectives are to provide a pasty or liquid culinary flavour concentrate that meets at least one of the objectives mentioned above, and at the same time provides a binding and/or thickening effect upon use in a cooking, boiling or heating process, e.g. by a consumer; and wherein further the concentrate is preferably not based on fat as a binder or thickener material, and where the concentrate is preferably even substantially free of fat; and where the concentrate is mainly based on natural ingredients.

The object of the present invention is achieved by the subject matter of the independent claims. The dependent claims further develop the idea of the present invention.

Accordingly, the present invention provides in a first aspect a method for making a pasty or liquid culinary flavor concentrate comprising the step of adding a crystalline salt and/or a crystalline sugar having an average particle size D50 of 150 μm or less to an aqueous composition comprising flavor compounds.

In a second aspect, the invention relates a pasty or liquid culinary flavor concentrate obtainable by the method of the present invention.

A still further aspect of the invention is a use of the pasty or liquid culinary flavor concentrate according to the present invention for the preparation of a food product.

It has been surprisingly found by the inventors, that when crystalline salt and/or sugar having an average particle size D50 of 150 μm or less are added to an aqueous culinary flavor composition instead of a same amount of salt and/or sugar in their regular commercial form of coarse crystals of average particle size of about 0.5 to 2 mm, a much more smooth and soft textured culinary flavor concentrate can be obtained. Particularly also, the such obtained flavor concentrate has a lower viscosity in comparison to the control concentrate made with regular salt and/or sugar crystals, with however fully maintaining the same low water activity as determined by the aw values. As for example demonstrated in further detail below in the Examples section, a culinary flavor concentrate made by an addition of 7.13 wt % of fine ground salt with a D50 value of 100 μm, had a viscosity of 31.1 Pa·s and a water activity aw of 0.76, in comparison to the same flavor concentrate made by the addition of 7.13 wt % coarse salt with a D50 value of about 500 μm, which had a viscosity of 35.2 Pa·s and the same water activity of aw 0.76.

One of the advantages is that the culinary flavor concentrate obtained by this method of the present invention has a lower stickiness than the control concentrate, which for example improves the discharge of the concentrate product from a packaging material. Furthermore, there is also no need to add other chemical ingredients which serve as plasticizer to improve the viscosity of the concentrate and do not increase the water activity at the same time, as for example certain alcohols, such as polyols. Hence, advantageously, a culinary flavor concentrate based on mainly natural ingredients can be produced.

Surprisingly, the inventors have found that the effect of lowering the viscosity of a concentrate with maintaining its water activity aw with using milled crystalline salt and/or sugar in its production process can be further improved by adding further sugar in a liquid format to the aqueous composition instead of as in solid form. For example, where the flavor concentrate was made with milled crystalline salt as mentioned above, the added crystalline sugar was replaced by an equal amount of the same sugar but in the form of sugar syrup in liquid form and of course the amount of added water adjusted accordingly. The viscosity of said sample concentrate was lowered from 31.1 Pa·s to 25.3 Pa·s and this with maintaining the water activity aw at 0.76. In fact, a minimal lower aw activity of 0.757 was even determined.

Hence, advantageously, both features of the present invention can be combined to provide an even better and more pronounced effect of lower viscosity and still same aw value of the obtained pasty or liquid culinary flavor concentrate.

Even further, the inventors have observed that where plant or animal material either as such or as dry extract were added, those could be replaced by the addition of an equivalent amount of extract or juice in a liquid format. If compensated correctly for the added amounts of water, such flavor concentrate products have a still even better improved viscosity than their control sample preparations and this with fully maintaining the same aw water activity. The same sample concentrate as mentioned above with having the plant and animal material added as liquid extract has a still further improved viscosity of 17 Pa·s and this with an overall water activity of only 0.752. Hence, the water activity was slightly reduced even further in comparison to the initial control sample. Further details on the experimental set-up are provided in the Example section.

Consequently, liquid and pasty concentrate products can now be obtained which have an improved viscosity over such similar prior art products, without having increased aw water activity levels, and without having used chemical plasticizers such as certain alcohols, like for example polyols, sorbitol, glycerol, propylene glycol, glycerol triacetate or isopropyl alcohol. Such products can now be more easily discharged from their packaging materials such as blisters, bottles, tubes and are also considered more natural and healthy by consumers because of the absence of chemical plasticizers.

### DETAILED DESCRIPTION OF THE INVENTION

The present invention pertains to a method for making a pasty or liquid culinary flavor concentrate comprising the step of adding a crystalline salt and/or a crystalline sugar having an average particle size D50 of 150 μm or less to an aqueous composition comprising flavor compounds.

A “pasty or liquid culinary flavor concentrate” is defined as a product suitable for flavoring food products either during or after cooking, boiling or heating. Particularly, such products can be added by a consumer to cold or hot water resulting in a bound sauce, fond or gravy. Furthermore the concentrate can be added directly to the fried meat into a hot pan being glazed with water, wine or fond resulting in a bound sauce or gravy. A “pasty” concentrate thereby refers to a concentrate product having an overall viscosity of from ca. 10 to ca. 40 Pa·s at 25° C.; a “liquid” concentrate refers to a concentrate product having an overall viscosity of from ca. 1 to ca. 10 Pa·s at 25° C., both measured at a shear rate of 10/s.

“Crystalline salt” refers mainly to kitchen salt in crystalline form. Thereby, salt is preferably sodium chloride (NaCl). It may also be preferred that salt next to NaCl further optionally comprises other alkali metal salts such as KCl or NH₄Cl. “Crystalline sugar” refers mainly to sugars such as glucose, fructose, sucrose, maltose in crystalline form.

Particle size is characterized by the “average particle size D50” which is the mean diameter defined as a 50% limit (D50) in particle distribution whereby 50% by volume of the particles have a diameter below the 50% limit and 50% by volume of the particles have a diameter above the 50% limit. In order to obtain such small average particle size of a crystalline salt or sugar, the salt or sugar can be milled or grinded according to known technologies such as with a high speed rotary grinding wheel cutter, ball mill (horizontal), Raymond mill (vertical), or coarse powder mill. Alternatively, such fine ground salt and/or sugars can be purchased directly from suppliers. The particle size of the milled filler can be analyzed for example by means of a laser diffraction particle sizer (e.g. from MASTERSIZER S, Malvern Instruments Ltd., Malvern/GB), coupled with a fully automated, air pressure controlled dry powder feeder (GMP ultra).

“Flavor compounds” comprised in the aqueous composition can be selected from the group of chemical flavoring compounds, yeast extract, monosodium glutamate (MSG), protein hydrolysates, natural flavor extracts and reaction flavor compounds.

The method of the present invention further comprises the step of adding a sugar in liquid form to the aqueous composition. The method of the present invention may further comprise the step of adding a juice or a liquid extract from a plant and/or an animal material to the aqueous composition. Thereby, the juice or liquid extract from the plant and/or animal material may be added to the concentrate comprising the milled crystalline salt and/or crystalline sugar; or to the concentrate comprising the milled crystalline salt and/or crystalline sugar in combination with the added sugar in liquid form. Advantageously, two or even all three features are combined in order to further improve the viscosity of the flavor concentrate without affecting negatively the water activity aw of said concentrate.

Preferably, the average particle size D50 of the crystalline salt and/or crystalline sugar in the method of the present invention is 100 μm or less, preferably 80 μm or less, even more preferably 50 μm or less. The smaller the average particle size of those crystalline ingredients is, the more smooth and soft the texture of the pasty liquid concentrate can be made; and the lower a viscosity of such a product can be achieved without compromising or increasing on the water activity aw.

In a preferred embodiment, the plant material used in the present invention is selected from the group consisting of vegetables, fruits, herbs and mushrooms, or a combination thereof. The animal material used in the present invention is preferably selected from the group consisting of meat, fish and crustacean, or a combination thereof.

The sugar in liquid form of the present invention can be any kind of sugar syrup. However, preferred is a sugar syrup, which has a low viscosity, a low water activity and which has a relatively low risk of re-crystallization of the comprised sugar compounds. Preferably, the sugar in liquid form is selected from the group consisting of glucose syrup, caramel syrup, dextrose syrup, fructose syrup, maltose syrup, or a combination thereof.

A further aspect of the present invention is a pasty or liquid culinary flavor concentrate obtainable by the method of the present invention, wherein the concentrate comprises 5-15 wt % salt, 1-20 wt % sugar, and a juice or extract from a plant and/or an animal material. Preferably, the concentrate comprises 7-13 wt % salt. A further preferred embodiment is where the concentrate comprises 3-15 wt % total sugar.

A still further preferred embodiment is where the concentrate comprises 7-13 wt % salt, 3-15 wt % sugar, and a juice or extract from a plant and/or an animal material.

The culinary flavor concentrate of the present invention may further comprise 10-35 wt % un-gelatinized starch, preferably 15-30 wt % un-gelatinized starch. The term “un-gelatinized starch” refers to starch that is in an un-swollen, semi-crystalline state. Due to birefringence, it presents maltese crosses when examined under the microscope with polarized light. During cooking the starch loses the birefringence, starts to absorb water which results in swelling of the starch granules and product thickening.

The advantage of the presence of un-gelatinized starch is that the starch is able to deliver thickening only in the final product upon cooking by the consumer and not in the concentrate itself.

The un-gelatinized starch of the present invention is preferably selected from starches that have a rather high gelatinization temperature such as corn starch, chemically modified starches, physically modified starches such as annealed or heat-moisture treated starch, preferably heat-moisture treated potato starch or native corn starch. Also a mixture of un-gelatinized starches can be used. Furthermore flours can be used as a source of starch.

The culinary flavor concentrate according to the present invention may comprise the juice or extract from a plant and/or an animal material in an amount from 0.5-15 wt, preferably from 0.5-10 wt %, more preferably from 0.5-5 wt %.

Typically, the culinary flavor concentrate according to the present invention has a water activity aw value within the range 0.6-0.8, preferably within the range 0.68-0.78, more preferably within the range 0.72-0.78. This selected range of aw guaranties a culinary flavor concentrate that is microbiologically safe. Hence, it can provide a shelf-stable pasty or liquid concentrate that is on one hand shelf-stable and microbiologically safe, and on the other hand still pasty and liquid enough to allow a good flow-ability and easy discharge of the culinary flavor concentrate from any kind of packaging material such as for example plastic blisters, glass or squeeze plastic bottles, or any other kind of containers.

Preferably, the culinary flavor concentrate of the present invention does not comprise a plasticizer selected from the group consisting of alcohols, polyols such as sorbitol and glycerol, propylene glycol, glycerol triacetate and/or isopropyl alcohol. Usually, consumers do not like the presence of such chemical compounds in their food products and it is therefore an advantage to provide a pasty or liquid flavor concentrate that does not comprise such chemical compounds.

Preferably, the culinary flavor concentrate according to the present invention does also not comprise more than 10 wt % fat, preferably not more than 5 wt % fat, more preferably not more than 2.5 wt % fat, even more preferably not more than 1.6 wt % fat. “Fat” as of the present invention is herein defined as a lipid composition which is solid at 20° C.

Today's consumers are more and more health conscious and like to limit the consumption of fat. Hence, the present concentrate preferably provides a low fat or even a fat free solution for consumers.

A still further aspect of the present invention is the use of the pasty or liquid culinary flavor concentrate according to the present invention for the preparation of a food product.

Those skilled in the art will understand that they can freely combine all features of the present invention disclosed herein. In particular, features described for the method of the present invention may be combined with the flavor concentrate of the present invention and vice versa. Further, features described for different embodiments of the present invention may be combined.

Further advantages and features of the present invention are apparent from the figures and examples.

### EXAMPLE 1

### Preparation of Culinary Flavor Concentrates

Samples of culinary flavor concentrates with the ingredients and amounts as listed in Table 1 were prepared as follows:

The powdered ingredients with the exception of starch were mixed with the water, pre-warmed to 50° C., until homogeneity was reached;

The remaining liquid ingredients with the exception of oil were added and mixed together;

The resulting pasty/liquid mass was pasteurized at 80° C. for 6 min, and then cooled down to 40° C.;

The starch, oil and/or fat were added to the pasteurized mass and mixed in homogenously;

The final concentrates were then filled into single portion plastic cups and sealed.

The products were stored at room temperature of 20° C. for at least one week.

### EXAMPLE 2

### Analysis of the Culinary Flavor Concentrates

### Viscosity

The viscosity of the samples were first tested visually and rated on a scale from 0 to 10 according to the following criteria:

0=very thick/pasty/non fluent concentrate;

1=slightly softer/finer concentrate;

2-3=softer/finer concentrate; concentrate starts to move when plastic caps are tilted;

4-9=thinner/softer/fluent concentrate; concentrate is more liquid and results in an improved to good discharge;

10=thin/liquid concentrate; perfect discharge, i.e. no rests in the cap.

In parallel, the viscosity was measured on a rotation rheometer “Physica MCR300” measuring the flow curve at different shear rates.

The results are indicated in Table 1.

### Water Activity aw

The water activity was determined by using a “Decagon AquaLab 4TE” with internal temperature control by thermoelectric (Peltier) components.

The results are indicated in Table 1.

### pH Values

The pH of the undiluted samples was measured potentiometric according to standard technology with a “Metrohm 780”.

The results are indicated in Table 1.

TABLE 1

| | Sample 1 | Sample 2 | Sample 3 | Sample 4 | Sample 5 |
|---|---|---|---|---|---|
| water | 30.167 | 30.167 | 29.373 | 28.340 | 25.640 |
| non-gelatinizsed starch | 31.733 | 31.733 | 30.667 | 30.667 | 30.667 |
| Xanthan | 0.035 | 0.035 | 0.035 | 0.035 | 0.035 |
| Salt D(50) = ca. 500 μm | 7.133 | | | | |
| Salt Fine Ground D(50) = 100 μm | | 7.133 | 7.133 | 7.133 | 7.133 |
| Glucose Syp 20-23DE Dehydrated | 3.067 | 3.067 | | 2.933 | |
| Glucose Syrup | | | 5.633 | | 5.633 |
| Caramel Instant Coarse | 2.400 | 2.400 | 2.400 | | |
| Caramel Sugar Syrup | | | | 6.133 | 6.133 |
| Chicken Powder Ultrafine | 2.000 | 2.000 | 2.000 | | |
| Chicken Extract Liquid | | | | 2.000 | 2.000 |
| Mushroom Extract Powder | 0.800 | 0.800 | 0.800 | | |
| Mushroom Liq 100% Juice Concentrate | | | | 0.800 | 0.800 |
| Paprika Oleoresin Powder | 0.040 | 0.040 | | | |
| Pepper Bell OleoresinLiq | | | 0.133 | 0.133 | 0.133 |
| Oil | 2.400 | 2.400 | 1.600 | 1.600 | 1.600 |
| Mix Flavor powder | 20.225 | 20.225 | 20.225 | 20.225 | 20.225 |
| Total input ingredients | 100.000 | 100.000 | 100.000 | 100.000 | 100.000 |
| viscosity (visually): scale 0-10 | 0 | 1 | 2 | 3 | 4 |
| viscosity (Pa * s at shear rate 10/s) | 35.2 | 31.1 | 25.3 | 17.4 | 17 |
| aw | 0.76 | 0.76 | 0.757 | 0.767 | 0.752 |
| pH | 4.58 | 4.58 | 4.55 | 4.49 | 4.477 |

All amounts are in wt %

### CONCLUSIONS

Sample 1 represents the Reference sample as known from the prior art.

Sample 2 is the equivalent to sample 1 with salt at D50=500 μm replaced with salt at D50=100 μm. Water activity aw value and pH are identical between samples 1 and 2. However, sample 2 has a lower viscosity of 31.1 Pa·s in comparison to sample 1, which has a higher viscosity at 35.2 Pa·s. The difference in viscosity can also be observed visually.

Sample 3 is a further equivalent to sample 1 with further having the dried glucose syrup replaced by the same glucose syrup in liquid form. The difference in total added water has been corrected for. The aw and pH values are quasi identical with the other samples 1 and 2. However, the viscosity has been further lowered to 25.3 Pa·s. The visual aspect of the sample viscosity has improved as well.

Sample 4 is still a further equivalent to samples 1 and 2, with having the caramel sugar, the chicken, mushroom and paprika extracts added in liquid form. The difference in total added water has been corrected for. Here as well, the aw and pH values are quasi identical with the other samples. The viscosity further improved to 17.4 Pa·s. The visual aspect of the sample viscosity has further improved as well.

Sample 5 is a still further equivalent to samples 1 and 2, but having the addition of all sugars, meat and plant extracts replaced by the equivalent liquid formats. The difference in total added water has been corrected for. Here again, the aw and pH values are quasi identical with the other samples. The viscosity further improved to 17.0 Pa·s, and the visual aspect of the sample viscosity has improved even further.

1. Method for making a pasty or liquid culinary flavor concentrate comprising the step of adding a crystalline salt and/or a crystalline sugar having an average particle size D50 of 150 μm or less to an aqueous composition comprising flavor compounds.

2. The method according to claim 1, comprising the step of adding a sugar in liquid form to the aqueous composition.

3. The method according to claim 1, further comprising the step of adding a juice or a liquid extract from a plant and/or an animal material to the aqueous composition.

4. The method according to claim 1, wherein the average particle size D50 is 100 μm or less.

5. The method according to claim 3, wherein the plant material is selected from the group consisting of vegetables, fruits, herbs and mushrooms, and combinations thereof.

6. The method according to claim 3, wherein the animal material is selected from the group consisting of meat, fish, crustacean, and combinations thereof.

7. The method according to claim 2, wherein the sugar in liquid form is selected from the group consisting of glucose syrup, caramel syrup, dextrose syrup, fructose syrup, maltose syrup, and combinations thereof.

8. A pasty or liquid culinary flavor concentrate obtainable by a method comprising the step of adding a crystalline salt and/or a crystalline sugar having an average particle size D50 of 150 μm or less to an aqueous composition comprising flavor compounds to the pasty or culinary flavor.

9. The culinary flavor concentrate according to claim 8 comprising:
5-15 wt % salt, 1-20 wt % sugar, and a juice or extract from a plant and/or an animal material.

10. The culinary flavor concentrate according to claim 8, further comprising 10-35 wt % un-gelatinized starch.

11. The culinary flavor concentrate according to claim 8, comprising the juice or extract from a plant or animal material in an amount from 0.5-15 wt %.

12. The culinary flavor concentrate according to claim 8, which has a water activity aw value within the range 0.6-0.8.

13. The culinary flavor concentrate according to claim 8, which does not comprise a plasticizer selected from the group consisting of alcohols, polyols such as sorbitol and glycerol, propylene glycol, glycerol triacetate and isopropyl alcohol, and combinations thereof.

14. The culinary flavor concentrate according to claim 8, which does not comprise more than 10 wt % fat.

15. A method for the preparation of a food product comprising adding thereto a pasty or liquid culinary flavor concentrate obtainable by a method comprising the step of adding a crystalline salt and/or a crystalline sugar having an average particle size D50 of 150 μm or less to an aqueous composition comprising flavor compounds.
